(19) United States
(12) Patent Application Publication
(10) Pub. No.: US 2025/0123486 A1
(43) Pub. Date: Apr. 17, 2025

(54) WEAPON SYSTEM AND WEAPON DISPLAY DEVICE THEREOF

(71) Applicant: EOTech, LLC, Plymouth, MI (US)

(72) Inventors: Brian Bellah, Orofino, ID (US); Todd Estes, Milford, MI (US); Waylin Wing, Ann Arbor, MI (US); Anthony Heath, Plymouth, MI (US); Joseph Brincat, Livonia, MI (US); Abram Summerfield, Orofino, ID (US)

(21) Appl. No.: 18/913,617

(22) Filed: Oct. 11, 2024

Related U.S. Application Data
(60) Provisional application No. 63/589,423, filed on Oct. 11, 2023.

(51) Int. Cl. G02B 27/01; F41G 1/387; F41G 11/00

(52) U.S. Cl. CPC G02B 27/0103; F41G 1/387; F41G 11/003; G02B 27/0149; G02B 2027/0141; G02B 2027/0154; G02B 2027/0161

(57) ABSTRACT

A weapon display device includes a display engine, a waveguide, and a chassis. The display engine is configured to selectively output light. The waveguide is configured to receive the light from the display and output graphics to the user. The chassis is coupled to the display engine and the waveguide, and is further configured to releasably mount to one of a weapon or an optic mounted to the weapon such that a field of view through the waveguide is aligned with an optical axis of the optic.

### CROSS-REFERENCE TO RELATED APPLICATION(S)

This application claims priority to and the benefit of U.S. Provisional Application No. 63/589,423, filed Oct. 11, 2023, the entire disclosure of which is incorporated by reference herein.

### TECHNICAL FIELD

This disclosure relates to weapon systems and, more specifically weapon systems and display devices that display information and graphics.

### BACKGROUND

Weapon sights are mounted to weapons to assist users in aiming the weapon. It would be advantageous if a weapon sight or display device were further able to selectively display and aiming graphic and changing information based on data collected by sensors associated with the weapon or a field in which the weapon is used.

### SUMMARY

Disclosed herein are implementations of weapon display devices and systems. In one implementation, a weapon display device includes a display engine, a waveguide, and a chassis. The display engine is configured to selectively output light. The waveguide is configured to receive the light from the display and output graphics to the user. The chassis is coupled to the display engine and the waveguide, and is further configured to releasably mount to one of a weapon or an optic mounted to the weapon such that a field of view through the waveguide is aligned with an optical axis of the optic.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic view of a weapon system having a weapon display device, a weapon, and a weapon sight.

FIG. 2 is an upper, front, right perspective view of an embodiment of the weapon display device of FIG. 1.

FIG. 3 is a right side view of a weapon system that includes the weapon display device and the weapon.

FIG. 4A is a perspective view of an exemplary optical system of the weapon display device of FIG. 1 having a display engine and a waveguide, including an optical path from the display to an eye of a user.

FIG. 4B is a simplified view of the optical path of FIG. 4A.

FIG. 5 is a side view of another weapon system having the display device, the firearm, and a first variation of an optic that is a magnifier.

FIG. 6 is a side view of another weapon system having the display device, the firearm, and a second variation of an optic that is a riflescope.

FIG. 7 is a side view of another weapon system having the display device, the firearm, and a third variation of an optic that is a holographic weapon sight that outputs a holographic aiming reticle.

FIGS. 8A and 8B are perspective views of the display device in a first configuration in which information and aiming graphics are output and a second configuration in which information graphics are not output.

FIGS. 9A and 9B are perspective views of a variation of the display device having a fixed aiming reticle in the first configuration and the second configuration of FIGS. 7A and 7B.

FIGS. 10 and 11 are upper, front, left and upper, rear, right perspective views, respectively, of the display device.

FIGS. 12A and 12B are side and front views, respectively, of the display device.

FIG. 13A is a front schematic view of a waveguide of the display device.

FIGS. 13B-13E are partial front schematic views of different embodiments of the display device, which depict in dashed lines hidden components, aspects of the waveguide, and a display area.

FIGS. 14A-14B are partial schematic side views of different embodiments of the display device with a focus adjustment.

FIGS. 14C and 14D are partial schematic side and top views of an embodiment of the display device with a display position adjustment.

FIGS. 15A-15D are side, top, front, and cross-sectional views of a weapon system with an embodiment of the display device.

FIGS. 16A-16E are schematic, side, top, front, and cross-sectional view of a weapon system with a display system.

### DETAILED DESCRIPTION

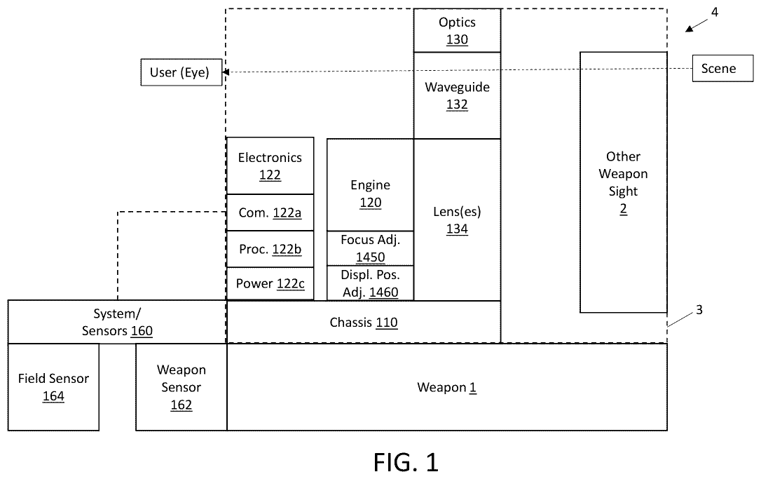

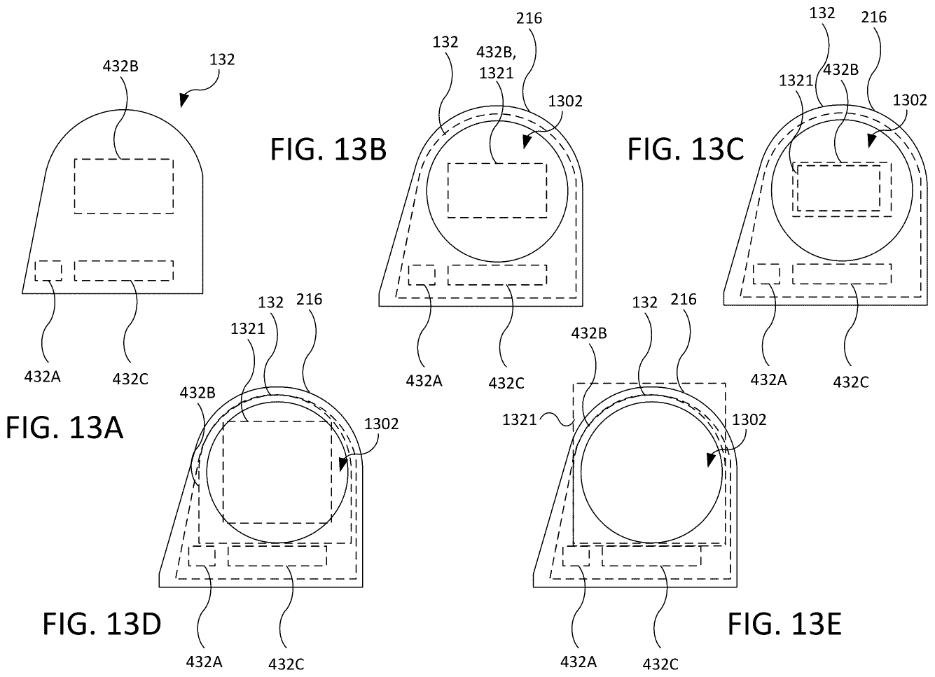

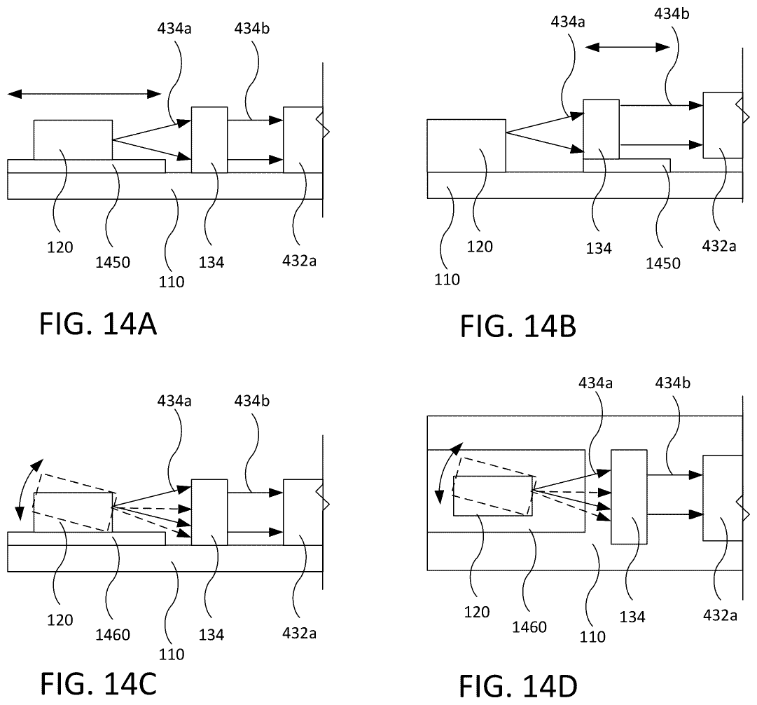

Referring to FIGS. 1-3 and 9-10, a weapon display device 100 is configured for a user to view a scene therethrough and augment the scene with graphics 240 according to various sensors or systems 160. The display device 100 may also be referred to as a display, display device, display system, or sight for a firearm or weapon. The sensors or systems 160 may be physically unassociated with the display device 100, a weapon 1 to which the display device 100 is mounted (e.g., a firearm), or the user, or may be physically associated therewith. Those of the sensors or systems 160 that are physically associated with the weapon 1 or the user may be referred to as weapon sensors 162, while those of the sensors or systems 160 that are not physically associated with the weapon 1 or the user may be referred to as field sensors 164.

The scene is viewed directly by the user through the display device 100. The display device 100 may also be referred to as a direct-view optic. More particularly, the display device 100 is transparent to provide a field of view (FOV) through which a user views the scene and overlays the graphics 240 with the scene.

The graphics 240 may, for example, include information graphics 242, an aiming graphic 244 (e.g., a reticle), or both. The information communicated by the information graphics 242 may provide users with increased situational awareness over other weapon sights that do not provide information graphics and/or that provide information graphics in other manners. The information graphics 242 may, for example, include information received or derived from the weapon sensors 162 associated with the weapon 1 or the display device 100 itself, such as ballistic information regarding the trajectory of particular ballistics, a count of remaining ammo rounds received from a computing device associated with the weapon 1, or remaining battery life of the display device 100. The information graphics 242 may include other information from the field sensors 164 that may, for example, include information pertaining to a target, team members, or physical environment.

In embodiments in which the graphics 240 include the aiming graphic 244, the aiming graphic 244 may indicate a point of contact of projectile fired from the weapon 1.

In one implementation, the display device 100 generally includes a chassis 110, a display engine 120 and associated electronics 122, and optics 130 that include a waveguide 132 and may further include one or more lenses 134. The display engine 120, the associated electronics 122, and the optics 130 are coupled to the chassis 110, which is in turn removably coupleable to a weapon 1, such as to a Picatinny rail of a firearm.

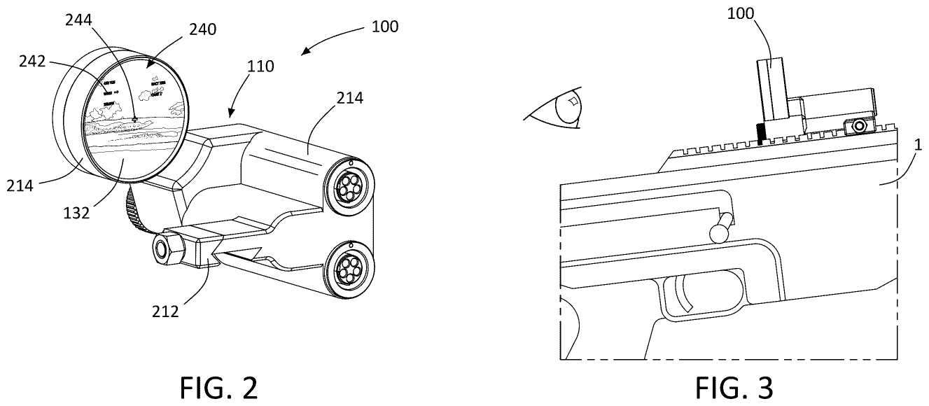

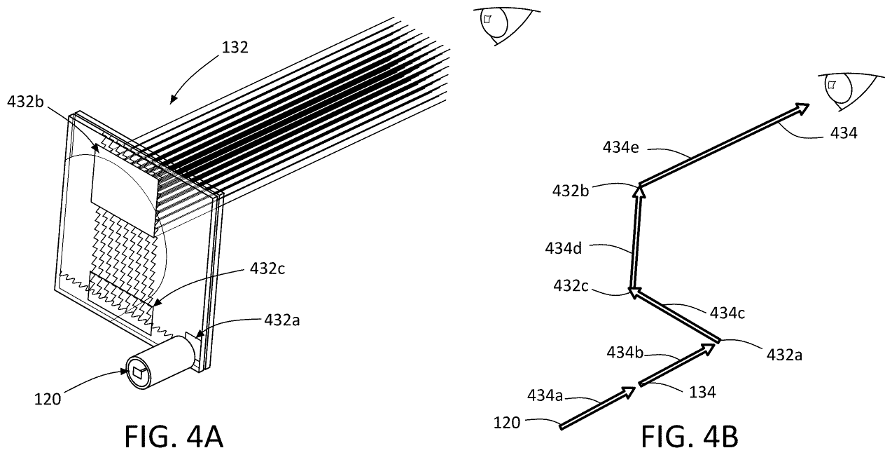

Referring to FIGS. 2-3, the chassis 110 includes one or more structural components to which the functional components of the display device 100 are coupled (e.g., the engine 120, the electronics 122, and the optics 130) and which supports such functional components. The chassis 110 generally includes a mounting portion 212, a housing 214, and a waveguide support 216. The mounting portion 212 is configured to removably couple to the weapon 1 independent of a another optic 2, such as to a Picatinny rail in a conventional manner, or to the optic 2, such as to the forward or rearward end of the optic 2. The display device 100 and the optic 2 may be referred to cooperatively as a weapon sight system 3, and the display device 100 and the weapon 1 with and without the optic 2 may be referred to cooperatively as a weapon system 4.

The mounting portion 212 may, for example as shown, include a structural member that defines a channel that receives the rail of the firearm 1 therein. The mounting portion 212 may, be formed of any suitable material via any suitable process (e.g., machining aluminum stock).

The housing 214 is configured to contain the display engine 120 and the associated electronics 122. The housing 214 defines one or more cavities in which the other components are contained. The various optical and electrical components contained therein may be coupled directly to the housing 214 or to intermediate structures or mechanisms that are in turn coupled to the housing 214. The housing 214 may be formed of one or more components from any suitable materials via any suitable process (e.g., casting aluminum). The housing 214 is coupled to the mounting portion 212 in any suitable manner, such as with fasteners, adhesives, and/or being formed monolithically therewith.

The waveguide support 216 is coupled to and supports the optics 130 and holds the waveguide 132 in a fixed (as show) or adjustable relationship relative to the mounting portion 212. The waveguide support 216 may generally define the field of view of the waveguide 132 therethrough, for example, as being circular and/or being large enough for an entire field of view of the optic 2 to be viewable therethrough. The waveguide support 216 may be opaque in other regions of the waveguide 132 outside the field of view. The display device 100 may be considered to have a central axis that extends through a center of the field of view and parallel with an optical axis of the optic 2 (e.g., also being substantially parallel with a firing axis of the weapon 1). The waveguide support 216 may be formed of one or more components from any suitable materials via any suitable process (e.g., casting aluminum). The waveguide support 216 is coupled to the housing 214 in any suitable manner, such as with fasteners, adhesives, and/or being formed monolithically therewith.

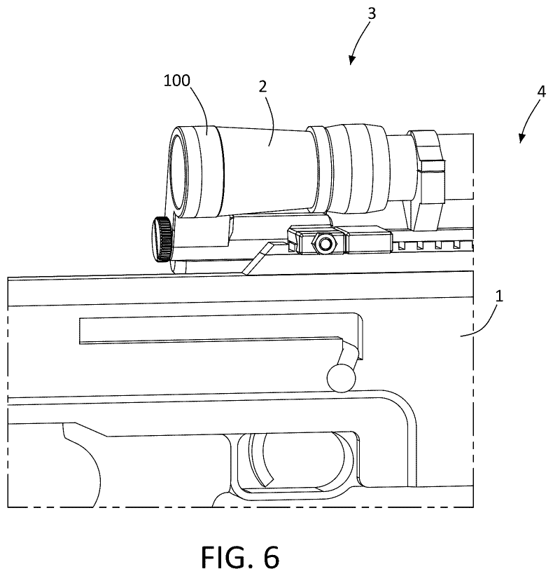

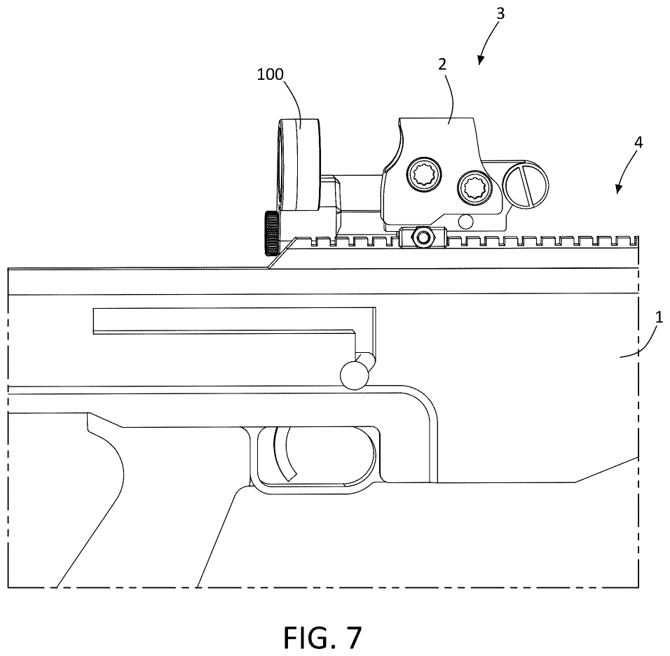

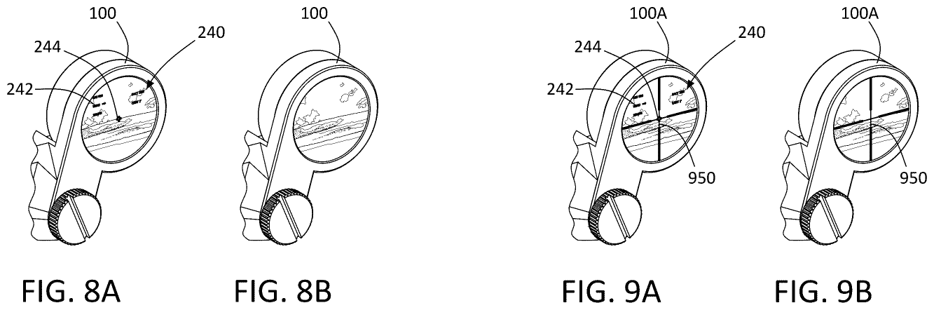

Referring to FIGS. 3 and 5-7, the chassis 110 is configured for the display device 100 to be used without the other optic 2 (see FIG. 3), with the other optic 2 (see FIGS. 5-7), or both (e.g., with the optic 2 on a flip mount). The display device 100 may be configured to mount between the scene or objective and the optic 2 (see FIG. 5) or between the user and the optic 2 (see FIGS. 6-7). As shown in FIGS. 5-7, the optic 2 is mounted to the weapon 1 independent of the display device 100, for example, being separately mounted to the Picatinny rail of the weapon 1.

When used with the optic 2, the display device 100 is optically aligned with the optic 2, such that the user views the scene through both the display device 100 and the optic 2. Both the display device 100 and the optic 2 are also aligned with the weapon 1, for example, such that any aiming reticles of the display device 100, whether graphical or analog, and the optic 2 are aligned with the weapon 1. The other optic 2 may be one of several different types of optics, including, but not limited to, a magnifier (as shown in FIG. 5), a riflescope (as shown in FIG. 6), or a holographic weapon sight (as shown in FIG. 7). The optic 2 may may referred to as a weapon sight or specific type of optic. The optic 2 may also be referred to as a primary optic, as the display device 100 may be used in conjunction therewith.

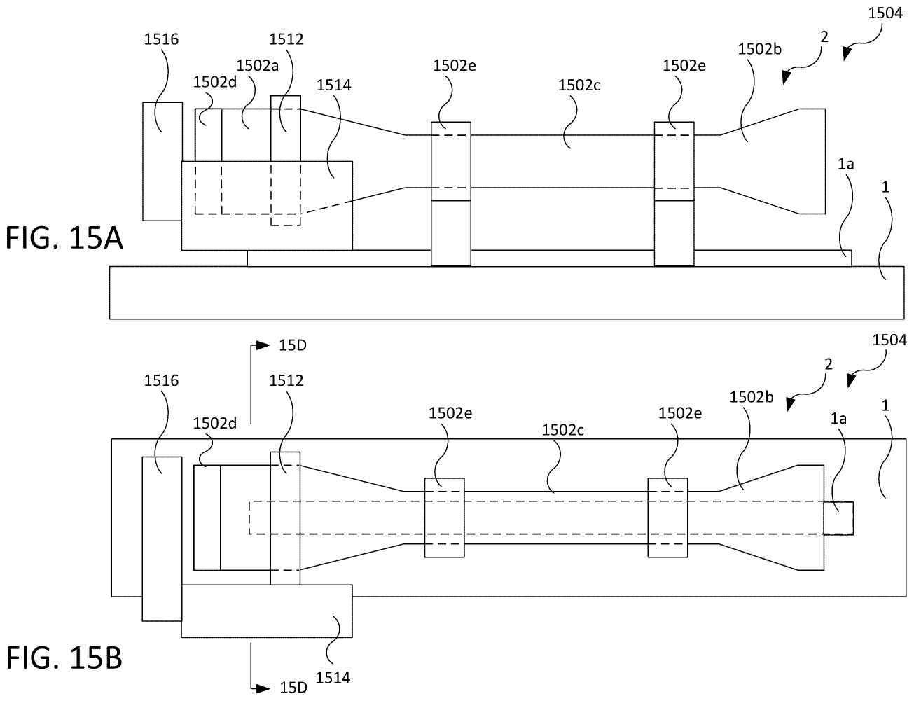

Furthermore, as illustrated in FIG. 6, use of the waveguide 130 in the display device 100, as opposed to other transparent displays (e.g., those employing beamsplitters), allows for packaging and physical configurations of the display device 100 that may provide various different benefits, including, for example, limiting visual restrictions to benefit user situational awareness, conserving space on the mounting rail, and/or occupying only a small portion of the eye relief when mounted between the optic 2 and the user. The housing 214 of the chassis 110 may be configured to be laterally offset, vertically offset (e.g., below), or both (as shown) and extend longitudinally (e.g., axially) away from the waveguide support 216 (e.g., forward away from the user). This arrangement may, as shown in FIG. 6, allow for the housing 214 of the chassis 110 to be positioned laterally outward and longitudinally overlap the optic 2 (e.g., axially or parallel with the firearm or aiming axes). As such, the waveguide 132, as supported by the waveguide support 216, may be positioned in close proximity to the optic 2 (e.g., the ocular end as shown, or the objective end). The mounting portion 212 may be positioned axially away from the waveguide 132 (e.g., away from the waveguide support 216), such that, as shown in FIG. 6, the mounting portion 212 couples to the mounting rail of the weapon 1 below the weapon sight 2, which may be in a region of the weapon sight 2 that is spaced further above the mounting rail than the end thereof proximate the waveguide 132 (e.g., the ocular end). Further, rather than various electrical and/or optical components being positioned generally over the mounting rail of the weapon and occupying rail space, many such components may be positioned laterally offset therefrom to be positioned alongside the other optic 2 (e.g., a battery of the display device 100 overlapping the axial dimension of the optic 2). Various relative dimensions and advantages thereof are discussed below with respect to FIGS. 12A and 12B.

In further examples (not shown), the display device 100 may be configured to mount directly to the optic 2, either to an ocular end of the optic 2, an objective end of the optic 2, or both.

The display engine 120 is configured to output light that, after passing through the waveguide 132, outputs the information graphics to the user. The display engine 120 may, for example, be a microdisplay, such as a liquid crystal on silicon (LCOS) display or micro-LED display, among others. The electronics 122 associated with the display engine 120 are configured to cause the display engine 120 to output the light and may, for example, include a communications interface 122a, a processor 122b, and power electronics 122c. The communications interface 122a is configured to send and/or receive signals to and/or from the display device 100 (e.g., from the external systems and sensors 160). The processor 122b, such as a central processing unit or other processing device, configured to process the signals received by the communications interface 122a and output signals to control the display engine 120 for outputting the light. The power electronics 122c are configured to provide electrical power to the communications interface 122a and the processor 122b, for example, including a power storage device (e.g., a battery) and any conditioning electronics suitable to condition the power output by the power storage device for use by the display engine 120 and the processor 122b.

The processor 122b may, for example, be a central processing unit or other controller, for example, having a processor, memory (e.g., volatile memory), storage (e.g., non-volatile), a communications interface, and bus by which the other components of the processor 122b or controller are in communication with each other.

Referring again to FIG. 1, the optics 130 include the waveguide 132 and may further include one or more lenses 134 through which light from the display engine 120 is passed and refracted before being received by the waveguide 132. The one or more lenses 134 may, individually or cooperatively, include or form a collimator.

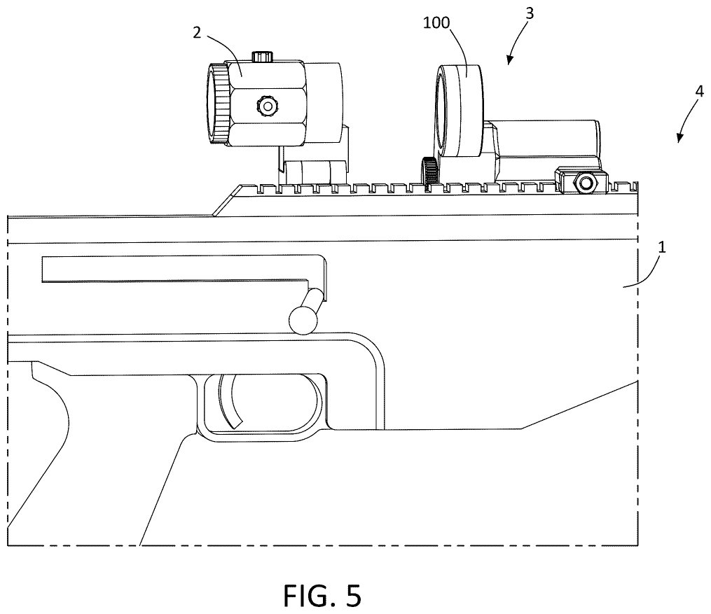

Referring to FIGS. 4A-4B, the waveguide 132 may, for example, include an input coupler 432a, an output coupler 432b, and a pupil expander 432c. The input coupler 432a, the output coupler 432b, and the pupil expander 432c are cooperatively configured to receive and diffract the light from display engine 120 to output the graphics 240 to the user along an optical path 434. The input coupler 432a, the output coupler 432b, and the pupil expander 432c may each be volume phase holograms. The waveguide 132 is substantially transparent, such that the user may directly view the FOV therethrough with graphics 240 being overlaid therewith. The input coupler 432a and the output coupler 432b may also be referred to, respectively, as first and second couplers. The optical path 434 includes a first segment 434a from the display engine 120 to the lenses 134, a second segment 434b from the lenses 134 to the input coupler 432a, a third segment 434c from the input coupler 432a to the pupil expander 432c, a fourth segment 434d from the pupil expander 432c to the output coupler 432b, and a fifth segment 434e from the output coupler 432b to the eye of the user.

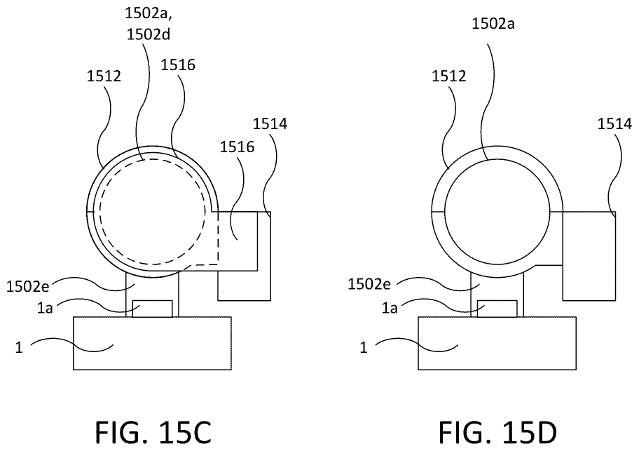

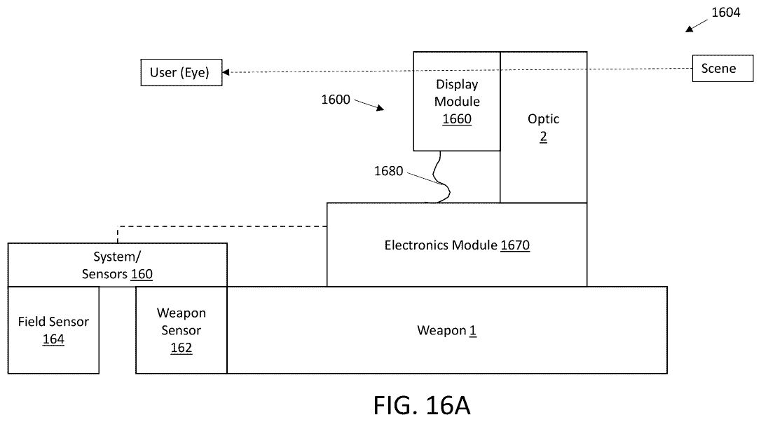

Spatial arrangements of the input coupler 432a, the output coupler 432b, the pupil expander 432c, the FOV, and the chassis 120 (e.g., the waveguide support 216) are discussed below with respect to FIGS. 13A-13E. Furthermore, the display device 100 may be configured with various mechanical and/or digital adjustments, which are discussed below with respect to FIGS. 14A-14D.

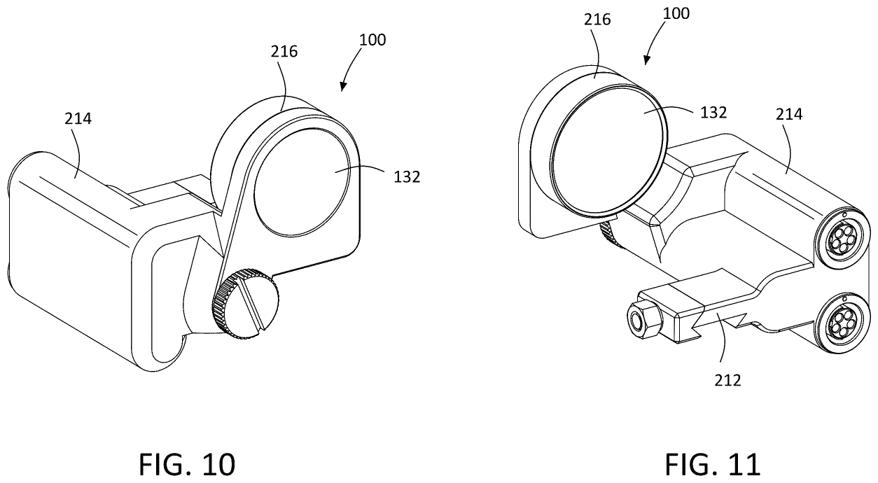

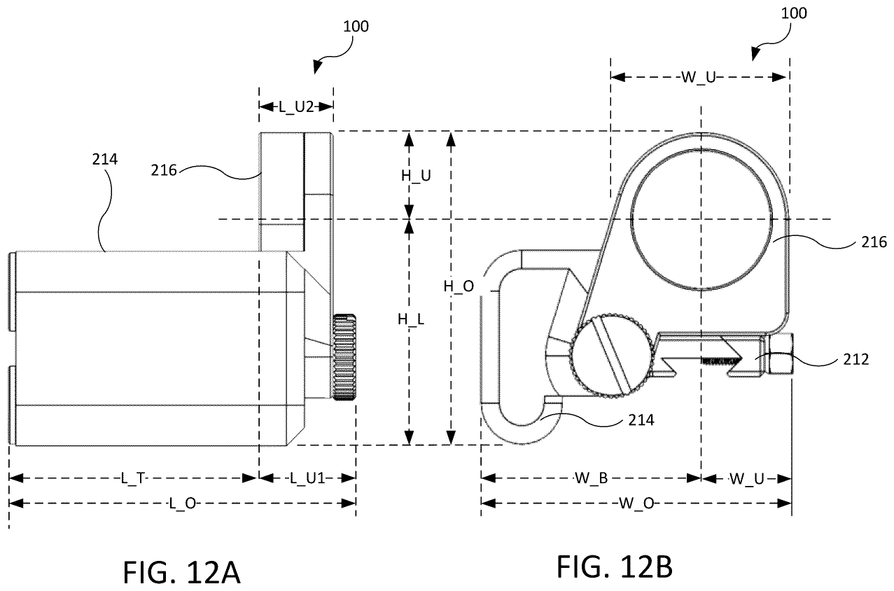

Referring to FIGS. 8A-8B, the display device 100 is configured for the user to selectively display the information graphics 242, the aiming graphic 244, or both. As shown in FIG. 8A, the user may directly view the scene through the display device 100 and, in particular, through the waveguide 132, while the information graphics 242 and the aiming graphic 244 are output to the user by the waveguide 132 and overlay the scene. As shown in FIG. 8B, the user may directly view the scene through display device 100 (i.e., through the waveguide 132), while the information graphics 242, the aiming graphic 244, or both (as shown) are not output to the user. In the case of the display device 100 including the aiming graphic 244 but not an analog aiming reticle (discussed below with respect to FIGS. 9A-9B), the location of the aiming graphic 244 may be adjusted electronically by the user (i.e., changing the graphical location of the aiming graphic 244 output relative to the chassis 110) to ensure that the aiming graphic 244 indicates a point of impact of a projectile fired by the weapon 1. In another example, the aiming graphic 244 may be in a fixed position relative to the chassis 110, while the display device 100 and, in particular, the chassis 110 may include mechanical adjustment mechanisms for adjusting windage, elevation, or both by which the chassis 110 and, thereby, the aiming graphic 244 is aligned with the point of impact of the projectile. For example, the aiming graphic 244 may be a holographic that is recorded in the output coupler 432b.

By use of the waveguide 132, various criteria may be satisfied for different applications, for example, contrast ratio for daylight bright environments, operability of a diopter adjustment, low impact on eye relief, and no refocusing by the user to view the graphics 240 (e.g., when changing between looking at the scene, such as a target within the scene, and the graphics 240).

Referring to FIGS. 9A-9B, a weapon display device 100A is a variation of the display device 100 and may further include an analog aiming reticle 950, which is a fixed analog pattern that may be applied to the waveguide 132 (e.g., to one of two opposing glass substrates of the waveguide 132). As with the display device 100, the display device 100 is configured for the user to selectively display the information graphics 242, the aiming graphic 244, or both. As shown in FIG. 9A, the aiming graphic 244 may be output in a complementary manner to the analog aiming reticle 950 (e.g., being a center dot or other aiming reticle within crosshairs formed by the analog aiming reticle 950). With the analog aiming reticle 950 being fixed on the waveguide 132 and, thereby, fixed relative to the chassis 110, the display device 100A may include the mechanical adjustment mechanisms for adjusting windage, elevation, or both by which the chassis 110 and/or the analog aiming reticle 950 are aligned with the point of impact of the projectile. Furthermore, during manufacturing, after manufacturing by the user, or both, the display device 100A may be calibrated such that the aiming graphic 244 is properly aligned with the analog aiming reticle 950, for example, to compensate for any mechanical tolerances between the chassis 110 and the waveguide 132.

Referring to FIGS. 12A and 12B, as mentioned above, various benefits may be provided by packaging of the display device 100 with lateral and/or vertical offsets of the display device 100 relative to the central axis of the display device 100 and/or the optical axis of the optic 2. The display device 100 may be defined according to relative dimensions. In considering the various dimensions, each of the mounting portion 212, the housing 214, and the waveguide support 216 may be considered to include other components attached thereto (e.g., covers for access components thereto, fasteners, user inputs, etc.). The dimensions are defined according to the display device 100 being in a fixed use position relative to the weapon 1 with the firearm axis being horizontal.

Referring to FIG. 12B, the display device 100 may be defined according to different width dimensions, which are those horizontal dimensions when viewing the display device 100 from the perspective of the user and in which the display device 100 might restrict forward viewing of the scene outside the field of view. The display device 100 has an overall width W_O, which is the horizontal dimension between the leftmost and the rightmost surfaces of the display device 100. The display device 100 also has a biased width W_B and an unbiased width W_U, which together equal the overall width W_O. The biased width W_B and the unbiased width W_U are the horizontal distances between the furthest side surface and the nearest side surface, respectively, of the display device 100 and the central axis of display device 100 or the optical axis of the optic 2. The furthest side surface may be an outer edge of the housing 214 (as shown), while the nearest side surface may be an outer edge of the mount 212, the waveguide support 216, or both (as shown). The biased width W_B may, for example, be more than 60%, 70%, or more of the overall width W_O, such as between 70% and 80%. The unbiased width W_U forms the remainder of the overall width W_O (e.g., less than 40%, 30%, or less thereof, or between 30% and 20%). The biased width with W_B may also be defined in relation to the unbiased width W_U, for example, being greater than 1.25, 1.75, or 2 times or more the size thereof (e.g., between 2 and 3 times, such as between 2.25 and 2.75 times). The display device 100 may be further defined according to an upper width W_U2, which is the dimension between the outer most surfaces above the central axis of the display device 100 and/or the optical axis of the optic 2. The upper width W_U2 may be significantly less than the overall width W_O, for example, being less than 80%, 70%, or 60% thereof (e.g., between 50% and 60%).

The display device 100 may be defined according to different height dimensions, which are those vertical dimensions when viewing the display device 100 from the perspective of the user (or from a side of the display device 100). The display device 100 has an overall height H O, which is the vertical dimension between the uppermost and the bottom most surfaces of the display device 100. The uppermost surface may be formed by an upper edge of the waveguide support 216 (as shown), and the lowermost surface may be formed by a lower edge of the housing 214 (as shown). The display device 100 also has an upper height H_U and a lower height H_L, which together equal the overall height H_O and are the vertical distances between the uppermost surface and the lowermost surface, respectively, and the central axis of the display device 100, the optical axis of the optic 2, or both. The lower height H_L may, for example, be more than 60%, 70%, or more of the overall height H_O (e.g., between 70% and 80%). The upper height H_U forms the remainder of the overall height H_O (e.g., less 40%, 30%, or less thereof, or between 30% and 20%). The lower height H_L may also be defined in relation to the upper height H_U, for example, being greater than 1.25, 1.75, or 2 times or more the size thereof (e.g., between 2 and 3 times, such as between 2.25 and 2.75 times). The overall height H_O may extend below the rail of the weapon 1.

By having majorities of the height and width of the display device 100 being biased toward one side and/or downward relative the central axis of the display device 100 and/or the optical axis of the optic 2, the display device 100 provides for high situational awareness by having few visual restrictions above the optical axis of the optic 2.

The display device 100 may be defined according to different length dimensions, which are those horizontal dimensions when viewing the display device 100 from a side in a horizontal direction perpendicular to the central axis of the display device 100 and/or the optical axis of the optic 2. The display device 100 has an overall length L_O, which is the horizontal dimension between surfaces nearest the target and the user. The surface nearest the target may be formed by the housing 214 (as shown), while the surface nearest the user may be formed by the housing 214 (as shown) or the waveguide support 216. The display device 100 also has a target side length L_T and a user side length L_U1, which together equal the overall length L_O. The target side length L_T and the user side length L_U1 are the horizontal distances between the surfaces of the display device 100 nearest the target and the shooter, respectively, and a surface of the waveguide 132 facing the target (e.g., at the center thereof). The target side length L_T may be greater than, 60%, 70%, 80% or more of the overall Length L_O, such as between 70% and 80%. By having the target side length L_T forming a majority of the overall length L_O, a majority of the length of the display device 100 may overlap in axial dimension of the optic 2, so as to conserve both the eye relief distance of the optic 2 (as discussed below) and mounting space on the rail of the weapon 1.

The display device 100 may be further considered to have upper length L_U2, which is the horizontal distance above the axes of the display device 100 and/or the sight 2 between the surfaces nearest the target and the shooter (e.g., between surfaces of the waveguide support 216). The upper length L_U2 may be less than 35%, 30%, 25% or less of the overall length L_O of the weapons display device 100. The upper length L_U2 may be less than 35%, 30%, 25%, 20%, or 15% of the designed eye relief distance of the optic 2 used therewith in the weapon system. The upper length L_U2 may also be less than the maximum dimension of the field of view of the display device 100 and/or the optic 2, such as less than 90%, 80%, 70%, 60% than the diameter thereof or other maximum dimension thereof perpendicular to the axis thereof. The upper length L_U2 may, for example, be less than 2.5, 2.0, 1.5, or fewer centimeters. With the upper length L_U2 of the display device 100 being relative small to the overall length and relative to the eye relief distance of the optic 2 used therewith (e.g., between approximately 8 and 13 centimeters), the display device 100 may occupy only a small portion of the eye relief distance (e.g., allowing for recoil). The upper length L_U2 may also be defined relative to the upper width W_U. The upper length L_U2 may be less than the upper width W_U, such as less than 80%, 70%, 60%, or 50% or less of the upper width W_U.

Referring to FIGS. 13A-13E, as referenced above, the display device 100 may include various different spatial arrangements of the waveguide 132 itself and relative to the chassis 120 (e.g., the waveguide support) and/or a display area output by the display engine 120 and other optical components.

As shown in FIG. 13A, the waveguide 132 is a single component that includes the input coupler 432a, the output coupler 432b, and the pupil expander 432c as diffraction gratings (e.g., volume phase holograms) formed in holographic media between substrates. The central axis of the display device 100 coincides with the output coupler 432b (i.e., passes therethrough), while the pupil expander 432c is positioned below the output coupler 432b, and the input coupler 432a is spaced laterally from the pupil expander 432c (e.g., leftward, as shown).

Referring additionally to FIGS. 13B-13E, the waveguide support 216 of the chassis 110 defines the field of view 1302 therethrough. The output coupler 432b coincides with the field of view 1302, such that the graphics 240 output thereby are viewable by the user along with the scene. The graphics 240 are output in a display area 1321, which is that region of the waveguide 132 to which the images output by the display engine 120 would be output by the output coupler 432b if the output coupler were in that same region (i.e., as output by the display engine 120 itself and/or transmitted through the lenses 134, the input coupler 432a, and the pupil expander 432c to the output coupler 432b). In each example, the input coupler 432a and the pupil expander 432c are positioned outside the field of view 1302 and not visible to the user, for example, behind an opaque portion of the waveguide support 216 or other portion of the chassis 110, such as the housing 120.

In the example shown in FIG. 13B, the output coupler 432b is smaller than and positioned entirely within the field of view 1302. The display area 1321 is sized to match and is positioned to coincide with the output coupler 432b, as indicated by a common lead from reference numerals 432b and 1321 being drawn to the same dashed box. In this configuration, the display engine 120 and the lenses 134 must be precisely located and oriented relative to each other and the waveguide 132 (e.g., the input coupler 432a). If not precisely oriented, only a portion of the display area 1321 overlaps the output coupler 432b, such that not all of the graphics 240 may be output to the user.

In another example shown in FIG. 13C, the output coupler 432b is larger than the display area 1321, for example, with both the output coupler 432b and the display area 1321 being rectangular. With the display area 1321 being smaller than the output coupler 432b, the display engine 120 and the lenses 134 may be located and oriented relative to each other and the waveguide 132 with less precision than the configuration of FIG. 13B, while allowing all graphics 240 to be output to the user (e.g., with the display area 1321 being off center relative to the output coupler 432c). In this instance, each of the other optical components (e.g., the lenses 134, the input coupler 432a, and the pupil expander 432c) are also larger in corresponding size than the display area 1321 to allow for less precise placement of the display engine 120 relative thereto.

In the example shown in FIG. 13D, the output coupler 432b is larger than the display area, for example, by being approximately the same size as the field of view (e.g., 80%, 90%, 100%, or more of the area. For example, as shown the output coupler 432b extends beyond the field of view 1302 and is partially out of view behind the waveguide support 216. The output coupler 432b may, for example, extend to edges of the waveguide 132 (e.g., with the waveguide 132 being cut or otherwise formed to final shape after formation of the output coupler 432b). The display area 1321 is contained entirely within the output coupler 432b and may (as shown) or may not extend outside the field of view 1302.

In the example shown in FIG. 13E, the output coupler 432a is approximately the same size as the field of view 1302 (as with the example in FIG. 13D), while the display area 1321 is larger than the output coupler 432a, for example, encompassing an entirety or near entirety of the output coupler 432a and the entire of the field of view 1302. In this example, positioning of the graphics 240 within the field of view 1302 may be performed graphically by selecting which of the pixels of the display engine 120 are utilized.

Referring to FIGS. 14A-14D, as referenced above, the display device 100 may include various mechanical adjustments for focusing the display device 100 and/or aligning the display engine 120 and/or the lenses 134 and, thereby, the display area 1321 relative to the output coupler 432b and/or the field of view 1302.

In each example, the display device 100 includes a focus adjustment 1450 (depicted schematically) that mechanically focuses the optical components to the user. The focus adjustment 1450 is also depicted schematically in FIG. 1. In each example, one of the display engine 120 or one or more of the lenses 134 is moved axially relative to the other (i.e., along a center of the optical path). As shown in FIG. 14A, the display engine 120 is linearly adjustable in axial position relative to the one or more lenses 134 to adjust focus of the display device 100 to the user and/or to the optic 2. The one or more lenses are in a fixed position relative to the chassis 120, while the display engine 120 is movably coupled to the chassis 120 via the focus adjustment 1450 that moves the display engine 120 axially (i.e., along a fixed axis) toward and away from the one or more lenses 134.

The focus adjustment 1450 includes a member that is movable relative to the chassis 120. The focus adjustment 1450 may be one of several different mechanisms, such as a lead screw, movement stage, or flexure, that moves the display engine 120. The focus adjustment 1450 may be operated manually in which case the user engages a mechanical input that moves the focus adjustment 1450 (e.g., a knob or lever) or electrically in which case a motor moves the focus adjustment 1450 (e.g., according to inputs received electronically from the user or from another source).

As shown in FIG. 14B, the one or more of the one or more lenses 134 is adjustable in axial position linearly relative to the display engine 120 to adjust focus of the display device 100 to the user and/or to the optic 2. The display engine 120 is in a fixed axial position relative to the chassis 120, while the one or more lenses 134 is movably coupled to the chassis 120 via the focus adjustment 1450 that moves the one or more lenses 134 axially (i.e., along a fixed axis) toward and away from the display engine 120. The focus adjustment 1450 may be one of several different mechanisms described previously with respect to FIG. 14A.

Referring to FIGS. 14C and 14D, the display engine 120 may additionally be adjustable rotationally in pitch (FIG. 14C) and yaw (FIG. 14D) relative to the one or more lenses 134 to adjust the display area 1321 relative to the output coupler 432b and/or the field of view 1302, for example, to align the display area 1321 with the field of view and/or to move the display area 1321 within the field of view 1302 according to user preference. The display device 100 includes a display position adjustment 1460 (depicted schematically), which pivots the display engine 120 in two substantially perpendicular axes (e.g., pitch and yaw) relative to the one or more lenses 134. The display position adjustment 1460 thereby changes the angle at which the light in the first segment 434a of the optical path 434 impinges on the nearest surface of the one or more lenses 134 to the display engine 120 (compare the solid lines and dashed lines of the display engine 120 and the first segment 434a of the optical path 434, which illustrate changes in rotational orientation in an exaggerated manner for illustrative purposes). The display position adjustment 1460 is also depicted schematically in FIG. 1.

The one or more lenses 134 are sized so as to receive the light from the display engine 120 in the first segment 434a of the optical path 434 at varying angles and positions on the nearest surface thereof, so as to output the light in the second segment 434b of the optical path 434 to the input coupler 432a in a suitable manner (e.g., without distortions, such as vignetting or aberrations, and without reducing the visible size of the display area 1321).

The display position adjustment 1460 includes a member that is movable relative to the chassis 120. The display position adjustment 1460 (depicted schematically) may be one of several different mechanisms, such as a lead screw, movement stage, or flexure, that pivots the display engine 120 and constrains such pivoting about the two pivot axes (e.g., pitch and yaw). The display position adjustment 1460 may be operated manually in which case the user engages a mechanical input that moves the display position adjustment 1460 (e.g., knobs and/or levers) or electrically in which case motors move the display position adjustment 1460 (e.g., according to inputs received electronically from the user or from another source).

Movement of the display area 1321 may be according to user preference (e.g., in the case of the output coupler 432b being larger than the display area 1321) or for functional purposes (e.g., in the case of aligning the display area 1321 with the output coupler 432b of similar size and shape, or aligning the aiming graphic 244 in a manner suitable for aiming the weapon 1). The display position adjustment 1460 may be used in conjunction with the focus adjustment 1450 as described with respect to FIG. 14A (i.e., in which the display engine 120 is moved axially) or as described with respect to FIG. 14B (i.e., in which one or more of the one or more lenses 134 is moved axially).

Instead of or in addition to mechanical adjustment, the position of the graphics 240 output by the display device 120 may instead be adjusted digitally, which is to say that different subsets of the pixels of the display engine 120 are utilized to output the graphics 240. Such adjustment may be according to user preference and/or functionality (e.g., alignment of the aiming graphic 240). Digital adjustment of the display area 1321 and/or the graphics 240 may be performed according to user or automated inputs, for example, as received through the communications interface 1221a.

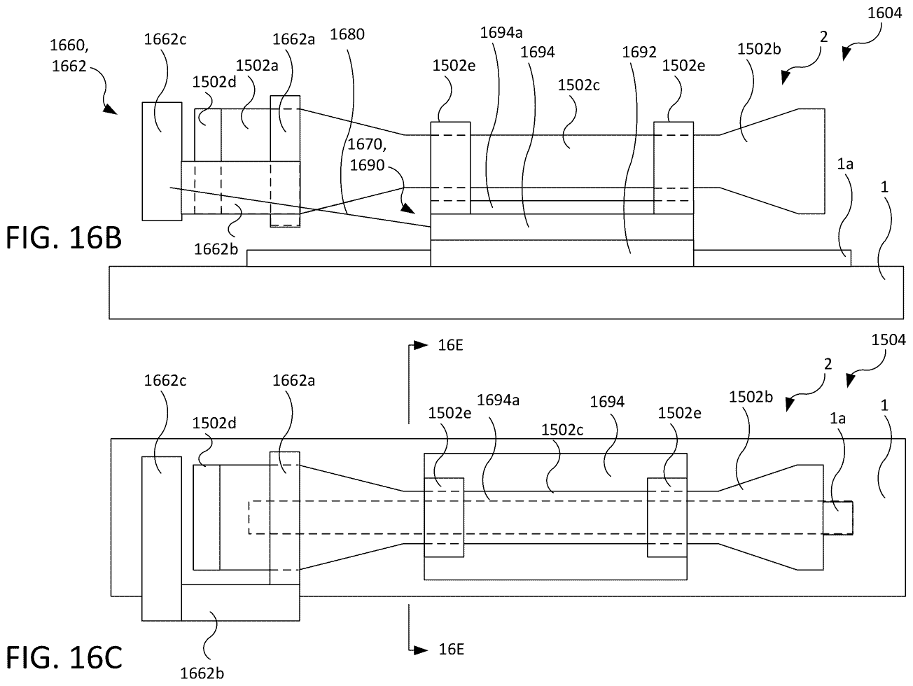

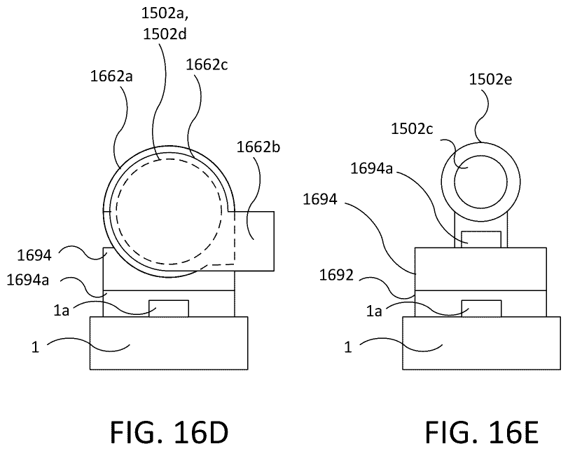

Referring to FIGS. 15A-16E, variations of the display device 100 may be packaged and configured to mount to the weapon 1 in different manners. Referring to FIGS. 15A-15D, a weapon system 1504 includes a weapon 1, the optic 2 that is a riflescope, and a display device 1500. In each of FIGS. 15A-15D, various hidden aspects of different components are illustrated in dashed lines. The optic 2 is mounted to the weapon 1 as described previously, for example, to the mounting rail 1a of the weapon 1. The display device 1500 is configured generally configured as described with respect to FIG. 1 (e.g., including the electronics 122, display engine 120, optics 132, waveguide 132, lenses 134, adjustments 1450 and/or 1460), while including a chassis 1510 that is configured to mount to the optic 2 instead of the mounting rail 1a of the weapon 1. The optic 2 generally includes an ocular end 1502a, an objective end 1502b, and a tubular portion 1502c extending therebetween the ocular end 1502b and the objective end 1502c. Each of the ocular end 1502a, the objective end 1502b, and the tubular portion 1502c include a housing and optical components (e.g., lenses) contained therein. The ocular end 1502a may further include a diopter adjustment 1502d, which may rotate relative to the housing of the ocular end 1502a to focus a reticle for a given user. The optic 2 further includes one or more mounts 1502e by which the optic 2 is mounted to the rail 1a of the weapon 1. The one or more mounts 1502e may, for example, include upper ends that clamp around the tubular portion 1502c and lower ends that couple to the rail 1a in a conventional manner.

The chassis 1510 of the display device 1500 generally includes a mounting portion 1512, a housing 1514, and a waveguide support 1516. The mounting portion 1512 is configured to mount the display device 1500 to the optic 2 and, in particular, to the housing of the ocular end 1502b (as shown) or, alternatively, to the tubular portion 1502c (not illustrated). The mounting portion 1512 may, for example, be a clamp that tightly surrounds the housing of the ocular end 1502b, for example, having an upper half of a ring that is fastened to a lower half to draw together to tight around the ocular end 1502b. The housing 1514 is coupled to and supported by the mounting portion 1512. The housing 1514 generally contains the electronics 122 and may further contain the display engine 120 and/or the lenses 134. The housing 1514 may, similar to the housing 214, extend axially alongside the optic 2 and/or be positioned substantially or entirely below the central axis of the display device 1500. The waveguide support 1516 is coupled to and supported by the housing 1516 between the user and the ocular end 1502b of the optic 2, so as to define the field of view therethrough and support the waveguide 132 relative to the optic 2 as described previously for the waveguide support 216. The waveguide support 1516 and the waveguide 132 therein may be spaced apart axially from the diopter adjustment 1502d to provide the user access to thereto and allow rotation thereof.

The display device 1500 may be dimensioned as described above with respect to the display device 100 (see discussion with respect to FIGS. 12A-12B) or other dimensions.

Referring to FIGS. 16A-16E, a weapon system 1604 includes the weapon 1, the optic 2, and a display system 1600. The display system 1600 generally includes a display module 1660 and an electronics module 1670 that are structurally separate but electrically connected via one or more cables 1680. The display module 1660 is coupleable to the optic 2 to be supported thereby in proper orientation and position for the field of view thereof to be aligned with the optical axis of the optic 2. The electronics module 1670 is coupleable to the weapon 1, such as to the mounting rail 1a there and may, as shown, be further configured as a mount for the optic 2.

The display module 1660 includes a chassis 1662, the display engine 120 and the optics 130 (i.e., the waveguide 132 and the lenses 134), along with other electronic components (e.g., circuity for receiving signals and power for the display module 1660 to output the graphics 240). The chassis 16662 includes a mounting portion 1662a, an arm portion 1662b, and a housing 1662c. The mounting portion 1662a is configured to couple to the optic 2 as described above with respect to the mounting portion 1512 of the display device 1500 (i.e., to the housing of the ocular end 1502a or the tubular portion 1502c). The arm portion 1662b is coupled to and is supported by the mounting portion 1662a and extends, for example and as shown, axially and adjacent to the optic 2 (e.g., being below the central axis of the waveguide 132 and/or field of view). The housing 1662c is configured similar to the waveguide supports 216, 1516 (i.e., by defining the field of view and supporting the waveguide 132), while also containing the optical engine 120 and the one or more lenses 134 and/or other electronic components (e.g., to connect to the cable 1680 and process signals and power). The arm portion 1662b may instead contain the optical engine 120, the one or more lenses 134, and/or the other electronic components. The chassis 1662 further includes the focus adjustment 1450 coupled thereto and may further include the graphic position adjustment 1460 (if provided), such as with the housing 1662.

The electronics module 1670 includes a chassis 1690 and the electronics 122 (e.g., the communications interface 122a, processor 122b, and power 122c, along with any other required circuitry and/or connectors for connecting the electronics module 1670 to the display module 1660 with cables 1680). The chassis 1690 generally includes a weapon mounting portion 1692 and a housing portion 1694. The weapon mounting portion 1692 is configured to mount to the weapon 1, such as to the mounting rail 1a. The housing portion 1694 contains therein the electronics 122.

As shown, the electronics module 1670 may also be configured as a mount for the optic 2. As shown, the electronics module may further include another mounting rail 1694a on an upper end thereof and to which the optic 2 is mounted with the one or more mounts 1502e (as described above and illustrated in FIGS. 15A-D. When the electronics module 1670 is mounted to the mounting rail 1a of the weapon 1, the mounting rail 1694a of the electronics module 1670 extends parallel therewith such that the optic 2 may be aligned with the mounting rail 1a of the weapon 1 and, thereby, the weapon 1. Alternatively, the electronics module may include the mounts 1502e integrated therewith, which are instead coupled and extend upward from the upper side of the housing portion 1694 without the mounting rail 1694a intervening therebetween.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A display system comprising:
a display engine configured to selectively output light;
a waveguide configured to receive the light from the display and output graphics to the user; and
a chassis coupled to the display engine and the waveguide, and further configured to releasably mount to one of a weapon or an optic mounted to the weapon such that a field of view through the waveguide is aligned with an optical axis of the optic.

2. The display system according to claim 1, wherein the waveguide includes an input coupler, an output coupler, and a pupil expander that are volume phase holograms and receive the light from the display and are cooperatively configured to output the graphics; and
wherein the electronics include a communications interface for receiving signals with information, a processor for processing the signals and providing display signals to the display to output the graphics according thereto, and power electronics for providing power to operate the communications interface and the processor

3. The display system according to claim 1, wherein the waveguide includes an input coupler, an output coupler, and a pupil expander that receive the light from the display and are cooperatively configured to output the graphics.

4. The display system according to claim 3, wherein the input coupler, the output coupler, and the pupil expander are volume phase holograms.

5. The display system according to any of claims 3, wherein the graphics include information graphics, an aiming graphic, or both.

6. The display system according to claim 5, wherein the graphics include the aiming graphic, and a position of the aiming graphic is adjustable by a user relative to the chassis by the display.

7. The display system according to claim 1, further comprising a lens that receives light from the display engine and transmits the light to the waveguide, and a focus adjustment that axially moves one of the lens or the display engine along relative to the chassis and the other of the lens or the display engine to focus the graphics for a user.

8. The display system according to claim 7, wherein the focus adjustment axially moves the display engine.

9. The display system according to claim 7, further comprising a display position adjustment that pivots the display engine about two perpendicular axes to adjust where the light from the display engine impinges on the lens to adjust a location of the graphics output by the waveguide.

10. The display system according to claim 1, further comprising electronics that are configured to operate the display for outputting the graphics to the user.

11. The display system according to claim 10, wherein the chassis includes a mounting portion configured to mount to a rail of a weapon, a housing coupled to and supported by the mounting portion and containing the electronics, and a waveguide support coupled to and supported by the housing and supporting the waveguide.

12. The display system according to claim 10, wherein the optic is a riflescope, and the chassis includes a mounting portion configured to mount to the riflescope, a housing coupled to and supported by the mounting portion and containing the electronics, and a waveguide support coupled to and supported by the housing and supporting the waveguide.

13. The display system according to claim 10, wherein the optic is a riflescope, and the display system includes a display module, an electronics module, and a cable transferring power and signals from the electronics module to the display module;
wherein the display module includes the display engine, the waveguide, and the chassis that is configured to mount to the riflescope; and
wherein the electronics module includes the electronics, is configured to mount to the weapon, and to mount the riflescope thereto.

14. The weapon display device according to claim 10, wherein the electronics include a communications interface for receiving signals with information, a processor for processing the signals and providing display signals to the display to output the graphics according thereto, and power electronics for providing power to operate the communications interface and the processor.

15. A weapon system comprising:
a weapon;
an optic coupled to the weapon, and
the weapon display device according to claim 1 coupled to the weapon.
